(19) United States
(12) Patent Application Publication
(10) Pub. No.: US 2025/0340692 A1
(43) Pub. Date: Nov. 6, 2025

(54) Golf Ball Functionalized Thermoplastic Elastomer

(71) Applicant: Topgolf Callaway Brands Corp., Carlsbad, CA (US)

(72) Inventor: Youhao Yang, Carlsbad, CA (US)

(73) Assignee: Topgolf Callaway Brands Corp., Carlsbad, CA (CA)

(21) Appl. No.: 19/092,632

(22) Filed: Mar. 27, 2025

Related U.S. Application Data
(60) Provisional application No. 63/642,184, filed on May 3, 2024.
(60) Provisional application No. 63/670,568, filed on Jul. 12, 2024.
(60) Provisional application No. 63/699,184, filed on Sep. 26, 2024.

(51) Int. Cl. C08G 18/32; A63B 37/00

(52) U.S. Cl. CPC C08G 18/3221; A63B 37/0023

(57) ABSTRACT

A golf ball comprising an acid functional thermoplastic polyurethane resin is disclosed herein. A golf ball comprising an acid functional thermoplastic polyurethane material is disclosed herein. The golf balls include polyols, isocyanates, and acid functional compositions. The golf ball compositions include preferred weight average molecular weights and number average molecular weights.

### CROSS REFERENCES TO RELATED APPLICATIONS

The Present Application claims priority to U.S. Provisional Patent Application Nos. 63/699,184, filed on Sep. 26, 2024; 63/670,568, filed on Jul. 12, 2024; and 63/642,184, filed on May 3, 2024 which are hereby incorporated by reference in their entirety.

### STATEMENT REGARDING FEDERALLY SPONSORED RESEARCH OR DEVELOPMENT

Not Applicable

### BACKGROUND OF THE INVENTION

### Field of the Invention

The present invention relates to elastomers. More specifically, the present invention relates to a thermoplastic elastomer.

### Description of the Related Art

Acid functional thermoplastic polyurethane can improve the compatibility between additives and a thermoplastic elastomer matrix. This hybrid blend could avoid blooming/leaching, improve material stability by better dispersing antioxidant, anti-UV and other processing aids. The acid functional groups can also improve the adhesion of a thermoplastic layer to the adjacent layers to prevent delamination. This material can be used in various applications such as automotive, electronics, food packaging, wire and cable products, hose and tube, adhesives, textile coatings, polymer impact modifiers, and sporting goods.

Various arts have been introduced in the past. For example, in U.S. Pat. No. 10,519,283 B2, Smetana proposed polymeric compositions for optical plastic lenses, the composition include polymers, colorants, inorganic particles, antioxidants, UV light stabilizer, and others. Colorants can be categorized as dye and pigment and they both have their own advantages/disadvantages. In U.S. Pat. No. 8,153,706, Vasudevan proposed a method to covalently attach dyes to the polymer and a dispersant covalently attached to a pigment to generate a polymeric colorant which can combine both the merits from pigment and dye in an inkjet composition. In U.S. Pat. No. 11,383,886, Cavallin et al proposed a method to use functionalized polymers including hydrogen, isocyanate, blocked isocyanate and ketone in packaging coatings applications. In U.S. Pat. No. 9,920,365, Shen introduced functionalized cyanine dyes with a linker moiety which can facilitate their conjugation to other species and optimize the optical properties of the dyes. In this invention, an acid functional thermoplastic polyurethane was designed and used as a secondary ingredient in a multi-component solid formulation to enhance its properties, including but not limited to color stability for injection molding parts including but not limited to sporting goods such as golf balls.

### BRIEF SUMMARY OF THE INVENTION

The present disclosure describes the use of this acid functional thermoplastic polyurethane in various injection molding application as it can improve multiple properties such as additive compatibilization, pigment/dye retainment, adhesion enhancement and surface energy alteration. The presently disclosed subject matter could be used in various thermoplastic elastomer systems. One approach would be to functionalize a thermoplastic polyurethane with acid functionality. The thermoplastic polyurethane may be composed of an isocyanate/polyol/chain extender, with an acid moiety incorporated from the polyol.

In this disclosure, an acid functional thermoplastic polyurethane was designed and used as a secondary ingredient in a multi-component solid formulation to enhance its properties, including but not limited to color stability for injection molding parts.

The Present disclosure could be used in various thermoplastic elastomer systems. One approach would be to functionalize a thermoplastic polyurethane with acid functionality. It is composed of isocyanate/polyol/chain extender, with an acid moiety incorporated from the polyol.

The use of an acid functional thermoplastic polyurethane in various injection molding application may improve multiple properties such as additive compatibilization, pigment/dye retainment, adhesion enhancement and surface energy alteration.

One aspect of the present disclosure is an acid functional thermoplastic polyurethane resin formed by the reaction of a copolymer polyol in an amount ranging from 60 to 70 weight percent, an isocyanate in an amount ranging from 20 to 30 weight percent, a chain extender in an amount ranging from 3 to 10 weight percent, and an acid functional oligomer or acid functional polyol in an amount ranging from 0.01 to 2.0 weight percent.

Another aspect of the present disclosure is an acid functional thermoplastic polyurethane material formed by the reaction of a copolymer polyol in an amount ranging from 60 to 70 weight percent, an isocyanate in an amount ranging from 20 to 30 weight percent, a chain extender in an amount ranging from 3 to 10 weight percent, and an acid functional oligomer or acid functional polyol in an amount ranging from 0.01 to 2.0 weight percent.

The acid functional thermoplastic polyurethane resin preferably has from 2 to 10 molar equivalent of hydroxyl groups. The acid functional thermoplastic polyurethane resin preferably has from 1 to 8 molar equivalent of isocyanate groups. The acid functional oligomer or acid functional polyol is preferably a carboxylated derivative of a polyester polyol, a sulfonated derivative of a polyester polyol, or a phosphonated derivative of a polyester polyol. The chain extender is preferably selected from the group consisting of ethylene glycol, diethylene glycol, propylene glycol, 1,5-pentanediol, and 1,6-hexanediol. The isocynanate is preferably selected from the group consisting of toluene diisocyanate, hexamethylene diisocyanate, isophorone diisocyanate, or para-phenylene diisocyanate. The acid functional thermoplastic polyurethane resin has a weight average molecular weight Mw<120 kDa and number average molecular weight Mn<50 kDa. The acid functional thermoplastic polyurethane resin preferably has an acid number less than 30.

Having briefly described the present disclosure, the above and further objects, features and advantages thereof will be recognized by those skilled in the pertinent art from the following detailed description of the invention when taken in conjunction with the accompanying drawings.

### BRIEF DESCRIPTION OF THE SEVERAL VIEWS OF THE DRAWINGS

FIG. 1 is a table of aging result with acid thermoplastic polyurethane masterbatches.

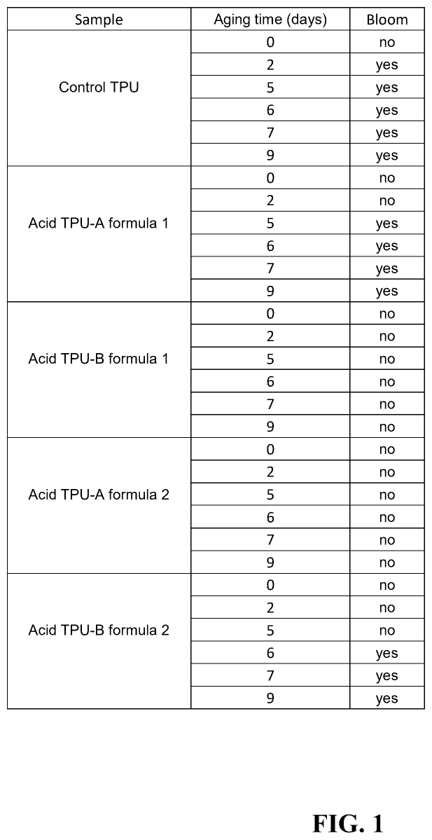

### DETAILED DESCRIPTION OF THE INVENTION

Acid functional thermoplastic polyurethane has been used in cast polyurethane for golf ball applications. However it has not been used in the injection molding applications for golf ball or other products/end users. This material can be used in compounding as well as injection molding. The introduction of carboxylic acid groups to the thermoplastic polyurethane matrix makes it possible to homogenously mix with various ionomers, resulting in improved golf ball performance, more specifically related to spin and durability.

A functionalized thermoplastic elastomer could be used for color stabilization and improved dispersion. Color stabilization is a well-known art in the industry where colorants can be functionalized to gain interparticle forces to avoid agglomeration and precipitation in the solvent.

The introduction of carboxylic acid groups to the thermoplastic polyurehtane matrix makes it possible to homogenously mix with various ionomers.

The invention of the functionalized thermoplastic polyurethane is quite versatile. Its acid functional groups can improve the miscibility/compatibility of thermoplastic polyurethane with other polymers, additives, fillers, pigments, dyes. Therefore, we can combine the mechanical benefits of thermoplastic polyurethane with additives without sacrificing the performance due to better mixing.

Acid functional thermoplastic polyurethane can be used by dry blends, twin screw compounding or single screw extrusion, injection molding, extrusion coating, blown or cast films.

The acid pendant groups can improve the adhesion between thermoplastic polyurethane and other materials such as, but not limited to polymers, ceramics, composites, glasses, metals, non-metals, semiconductors, adhesives, coatings, and paints.

Using acid thermoplastic polyurethane in a polymer masterbatch can potentially improve carrier capability to load more fillers/modifiers/dyes/pigments/additives compared with normal thermoplastic polyurethane, this can provide great flexibility when processing with multiple additives in injection molding step. One potential benefit of acid functional thermoplastic polyurethane is blooming/migration prevention. The acid pendant groups can provide better attraction to secure the small molecules from leaching/migrating to the surface. This feature can be useful for color preservation of any injection molded plastic parts.

Acid functional thermoplastic polyurethane can help maintain colors on injection molding objects including golf balls due to the better compatibility/miscibility from the acid functional groups.

Besides, the performance of the golf ball can also be improved. Acid functional thermoplastic polyurethane can reduce the hardness of the ball, provide soft touch feeling while maintaining or improving the ball speed and ball durability. Using acid functional thermoplastic polyurethane in a hybrid cover formulation can combine the benefit of ionomer and thermoplastic polyurethane and form a new category of golf ball in the market.

Acid functional thermoplastic polyurethane can improve the compatibility between additives and a thermoplastic elastomer matrix. This hybrid blend could avoid blooming/leaching, improve material stability by better dispersing antioxidant, anti-UV and other processing aids. The acid functional groups can also improve the adhesion of a thermoplastic layer to the adjacent layers to prevent delamination. This material can be used in various applications such as automotive, electronics, food packaging and sporting goods.

To demonstrate the efficacy of acid functional thermoplastic polyurethane for blooming improvement, three different yellow masterbatches were made including one control thermoplastic polyurethane masterbatch and two acid functional thermoplastic polyurethane masterbatches. The dosage of yellow pigment/additives packages for each masterbatch is about 5 to about 50% and preferably about 10 to about 40% with the carrier dosage about 50 to about 95% and preferably about 60 to about 90%.

The masterbatch compounds are made with a twin-screw extruder. Due to the different carrier thermoplastic polyurethane, the screw speeds can be varied from 200 to 400 rpm and die temperatures can be varied from 150 to 210° C. After the masterbatch are compounded and pelletized, they are blended with a control thermoplastic polyurethane without acid functional groups and injection molded into plaques for the upcoming aging test in an incubator. The incubator is set up at 150F and 80% RH to mimic an accelerated aging environment.

Aging result is summarized in Table 1. The control thermoplastic polyurethane plaques bloom in 2 days after aging in the incubator. Acid TPU-A formula 1 blooms in 5 days and formula 2 does not bloom after 9 days. Similar improvement can be observed in another acid functional thermoplastic polyurethane. Acid TPU-B formula 1 does not bloom after 9 days and formula 2 blooms in 6 days. All the formula with acid functional thermoplastic polyurethane dramatically increases time-to-bloom compared to the control thermoplastic polyurethane. According the the Arrhenius-Peck Relationship, 2 days aging at 150F and 80% RH equals to 180 days in ambient condition. By adding the acid functional thermoplastic polyurethane yellow masterbatch, the time-to-bloom increased more than 4 times from 180 days to 2 years and 80 days. This result showed the strength of acid functional thermoplastic polyurethane in color preservation to avoid blooming in the injection molded parts.

In one embodiment, an acid functional thermoplastic polyurethane resin formed by the reaction of a copolymer polyol in an amount ranging from 60 to 70 weight percent, an isocyanate in an amount ranging from 20 to 30 weight percent, a chain extender in an amount ranging from 3 to 10 weight percent, and an acid functional oligomer or acid functional polyol in an amount ranging from 0.01 to 2.0 weight percent.

In an alternative embodiment, the acid functional thermoplastic polyurethane resin preferably has from 2 to 10 molar equivalent of hydroxyl groups. The acid functional thermoplastic polyurethane resin preferably has from 1 to 8 molar equivalent of isocyanate groups. The acid functional oligomer or acid functional polyol is preferably a carboxylated derivative of a polyester polyol, a sulfonated derivative of a polyester polyol, or a phosphonated derivative of a polyester polyol. The chain extender is preferably selected from the group consisting of ethylene glycol, diethylene glycol, propylene glycol, 1,5-pentanediol, and 1,6-hexanediol. The isocynanate is preferably selected from the group consisting of toluene diisocyanate, hexamethylene diisocyanate, isophorone diisocyanate, or para-phenylene diisocyanate. The acid functional thermoplastic polyurethane resin has a weight average molecular weight Mw<120 kDa and number average molecular weight Mn<50 kDa. The acid functional thermoplastic polyurethane resin preferably has an acid number less than 30.

The acid functional oligomer or acid functional polyol is preferably a carboxylated derivative of a polyester polyol, a sulfonated derivative of a polyester polyol, or a phosphonated derivative of a polyester polyol.

The isocynanate is preferably selected from the group consisting of toluene diisocyanate, hexamethylene diisocyanate, isophorone diisocyanate, or para-phenylene diisocyanate.

The chain extender is selected from the group consisting of ethylene glycol, diethylene glycol, propylene glycol, 1,5-pentanediol, and 1,6-hexanediol.

The acid functional thermoplastic polyurethane material has an acid number less than 30.

Chavan, U.S. Pat. No. 11,865,410 for a Golf Ball With An Acid-Functional Polyurethane Hybrid is hereby incorporated by reference in its entirety.

From the foregoing it is believed that those skilled in the pertinent art will recognize the meritorious advancement of this invention and will readily understand that while the present invention has been described in association with a preferred embodiment thereof, and other embodiments illustrated in the accompanying drawings, numerous changes, modifications and substitutions of equivalents may be made therein without departing from the spirit and scope of this invention which is intended to be unlimited by the foregoing except as may appear in the following appended claims. Therefore, the embodiments of the invention in which an exclusive property or privilege is claimed are defined in the following appended claims.

I claim as our invention the following:

1. An acid functional thermoplastic polyurethane resin formed by the reaction of
a copolymer polyol in an amount ranging from 60 to 70 weight percent,
an isocyanate in an amount ranging from 20 to 30 weight percent,
a chain extender in an amount ranging from 3 to 10 weight percent,
an acid functional oligomer or acid functional polyol in an amount ranging from 0.01 to 2.0 weight percent, and
a masterbatch compound comprising 5 to 50 weight percent inorganic or organic pigment and 50 to 95 weight percent carrier polymer.

2. The acid functional thermoplastic polyurethane resin according to claim 1 wherein the resin has from 2 to 10 molar equivalent of hydroxyl groups.

3. The acid functional thermoplastic polyurethane resin according to claim 1 wherein the resin has from 1 to 8 molar equivalent of isocyanate groups.

4. The acid functional thermoplastic polyurethane resin according to claim 1 wherein the acid functional oligomer or acid functional polyol is a carboxylated derivative of a polyester polyol, a sulfonated derivative of a polyester polyol, or a phosphonated derivative of a polyester polyol.

5. The acid functional thermoplastic polyurethane resin according to claim 1 wherein the chain extender is selected from the group consisting of ethylene glycol, diethylene glycol, propylene glycol, 1,5-pentanediol, and 1,6-hexanediol.

6. The acid functional thermoplastic polyurethane resin according to claim 1 wherein the isocynanate is selected from the group consisting of toluene diisocyanate, hexamethylene diisocyanate, isophorone diisocyanate, or para-phenylene diisocyanate.

7. The acid functional thermoplastic polyurethane resin according to claim 1 wherein the acid functional thermoplastic polyurethane resin has a weight average molecular weight Mw<120 kDa and number average molecular weight Mn<50 kDa.

8. The acid functional thermoplastic polyurethane resin according to claim 1 wherein the acid functional thermoplastic polyurethane resin has an acid number less than 30.

9. An acid functional thermoplastic polyurethane material formed by the reaction of a copolymer polyol in an amount ranging from 60 to 70 weight percent,
an isocyanate in an amount ranging from 20 to 30 weight percent,
a chain extender in an amount ranging from 3 to 10 weight percent,
an acid functional oligomer or acid functional polyol in an amount ranging from 0.01 to 2.0 weight percent, and
a masterbatch compound comprising 5 to 50 weight percent inorganic or organic pigment and 50 to 95 weight percent carrier polymer.

10. The acid functional thermoplastic polyurethane material according to claim 9 wherein the acid functional thermoplastic polyurethane material has from 2 to 10 molar equivalent of hydroxyl groups.

11. The acid functional thermoplastic polyurethane material according to claim 9 wherein the material has from 1 to 8 molar equivalent of isocyanate groups.

12. The acid functional thermoplastic polyurethane material according to claim 9 wherein the acid functional oligomer or acid functional polyol is a carboxylated derivative of a polyester polyol, a sulfonated derivative of a polyester polyol, or a phosphonated derivative of a polyester polyol.

13. The acid functional thermoplastic polyurethane material according to claim 9 wherein the chain extender is selected from the group consisting of ethylene glycol, diethylene glycol, propylene glycol, 1,5-pentanediol, and 1,6-hexanediol.

14. The acid functional thermoplastic polyurethane material according to claim 9 wherein the isocynanate is selected from the group consisting of toluene diisocyanate, hexamethylene diisocyanate, isophorone diisocyanate, or para-phenylene diisocyanate.

15. The acid functional thermoplastic polyurethane material according to claim 9 wherein the acid functional thermoplastic polyurethane material has a weight average molecular weight Mw<120 kDa and number average molecular weight Mn<50 kDa.

16. The acid functional thermoplastic polyurethane material according to claim 9 wherein the acid functional thermoplastic polyurethane material has an acid number less than 30.

17. An acid functional thermoplastic polyurethane resin formed by the reaction of
a copolymer polyol in an amount ranging from 60 to 70 weight percent,
an isocyanate in an amount ranging from 20 to 30 weight percent,
a chain extender in an amount ranging from 3 to 10 weight percent, and an acid functional oligomer or acid functional polyol in an amount ranging from 0.01 to 2.0 weight percent.

18. The acid functional thermoplastic polyurethane resin according to claim 17 wherein the acid functional thermoplastic polyurethane resin has a weight average molecular weight Mw<120 kDa and number average molecular weight Mn<50 kDa.

19. The acid functional thermoplastic polyurethane resin according to claim 17 wherein the acid functional thermoplastic polyurethane resin has an acid number less than 3.
